(19) United States
(12) Patent Application Publication
(10) Pub. No.: US 2024/0140679 A1
(43) Pub. Date: May 2, 2024

(54) Microwavable Package Having Susceptors

(71) Applicant: H. J. Heinz Company Brands LLC, Pittsburgh, PA (US)

(72) Inventors: Saman Noor Khorasi, Lilburn, GA (US); Alanna Patricia Fallone, Penfield, NY (US); Eric Sitterly, Mars, PA (US)

(21) Appl. No.: 18/495,207

(22) Filed: Oct. 26, 2023

Related U.S. Application Data
(60) Provisional application No. 63/472,184, filed on Jun. 9, 2023.
(60) Provisional application No. 63/420,318, filed on Oct. 28, 2022.

(51) Int. Cl. B65D 81/34; A47J 36/02; H05B 6/64

(52) U.S. Cl. CPC B65D 81/3453; A47J 36/027; H05B 6/6494; B65D 2205/02; B65D 2581/3495; B65D 2581/3497; B65D 2581/3498

(57) ABSTRACT

A microwavable package including at least one susceptor can be configured for use with microwave heating of a packaged food product. The package can include at least one vent opening, such as on a bottom wall, to vent moisture from the package during microwave heating. The package can further include an absorbent material positioned adjacent the vent opening to absorb moisture therethrough. The package may also include additional vent openings such as at a lid or side walls.

### CROSS-REFERENCE TO RELATED APPLICATIONS

This application claims benefit of U.S. Provisional Application No. 63/420,318, filed Oct. 28, 2022, and U.S. Provisional Application No. 63/472,184, filed Jun. 9, 2023, which are hereby incorporated herein by reference in their entirety.

### FIELD

This disclosure relates to packaging for food products and more particularly to microwavable packaging for comestibles.

### BACKGROUND

Comestibles, such as convenience food items, require little preparation by consumers and can be eaten shortly after purchasing or heating in a microwave oven. One of the problems associated with the use of microwave energy (i.e., electromagnetic radiation at a frequency of about 0.3 to 300 GHz, commonly about 2.45 GHz) for cooking of food items in microwave ovens is nonuniformity of heating of the food items. Substantial temperature variation may be present where uniformity of temperature is desired. The problem is in part due to the fact that power distribution in the oven cavity is typically non-uniform. The non-uniform power density gives rise to “hot spots” and “cold spots” within the cavity.

Also contributing to the problem is the fact that a food item generally does not exhibit uniform temperature response to microwave radiation throughout its volume during a typical heating cycle. In particular, when a food item is subjected to microwave radiation, certain portions of the item may cook before other portions, and may become overcooked while other portions remain undercooked.

Numerous efforts have been made to address the problem of uniformity of heating. Various types of turntables, susceptors, reflectors, and shields have been proposed as solutions. However, devices which are useful in certain commercially available microwave ovens may not exhibit acceptable performance in other ovens, due to variations in power, cavity size and field configuration. Also, some devices which may improve cooking are unacceptable due to their tendency to cause arcing or sparking. Furthermore, devices which shield a food item and/or reflect radiation away from the food item may increase the cooking time of the food item. Typical food items have non-homogenous thermal resistivity and non-homogenous dielectric properties. Furthermore, the dielectric properties of such items often vary during cooking. These factors tend to further complicate efforts to improve cooking rate and uniformity. Among the considerations that may be taken into account in developing new convenience food items is the ability of the packaging to facilitate microwave heating while addressing these problems.

Even when susceptors are used in food packaging, the performance of the susceptor material can be impacted by whether the susceptor material comes into contact with the foods. Similarly, the patterning and amount of susceptor material may impact performance.

Furthermore, when using relatively closed packaging with one or more susceptors, moisture collects inside the package, condenses, and can be reabsorbed into the sandwich, resulting in a chewy tough product. This can also create uneven crispiness with soggy or soft spots as well as chewy and tough edges. For example, moisture can collect towards the bottom of the package and/or food product, resulting in a bottom portion that is soggy. In some forms, a consumer may place a microwavable package directly on the bottom surface of the microwave. When positioned in this manner, moisture may collect underneath the comestible in the package, resulting in soggy portions and/or chewy portions. This problem can be compounded when multiple susceptors are used on different surfaces within the cooking space in the package as the comestible may not heat evenly, especially in view of moisture on the bottom of the comestible.

### SUMMARY

A microwavable package for a comestible is provided for achieving desirable cooking of the comestible while permitting moisture migration. The package may also help provide for desirable cooking performance along different surfaces of the comestible. For example, in the case of a sandwich, venting and different forms of susceptors can be provided to heat the top and/or bottom of the sandwich in a different manned than the sides of the sandwich. Various amounts and types of susceptors can be provided at different locations along with venting at different locations to provide for a desirable moisture balance in the packaging. Similarly, the packaging may be reconfigurable so that the dimensions between different walls, such as the top and bottom wall, can be modified to accommodate different sized foods. This can permit both the top and bottom walls, and thus susceptor materials, to contact different sized foods in the same packaging, thus providing desirable crisping of the top and bottom surfaces.

According to some forms, the microwavable package includes a bottom wall, a top wall, at least one side wall, and a susceptor layer. The bottom walls define a vent opening extending at least partially through the bottom wall. The at least one side wall is positioned between the bottom wall and the top wall. The at least one side wall, bottom wall, and top wall generally surround a comestible cooking space. The susceptor layer is positioned at the bottom wall facing the comestible cooking space with the vent opening extending through the susceptor layer.

In some forms, the package includes a bottom wall, a plurality of side walls, a top wall, a bottom susceptor layer, a top susceptor layer, a side susceptor layer, and absorbent material. The bottom wall defines a bottom vent opening extending at least partially through the bottom wall. The plurality of side walls extends from the bottom surface. The top wall forms a lid operably coupled to at least one of the plurality of side walls. The top wall, bottom wall, and plurality of side walls generally surround a comestible cooking space. The bottom susceptor layer is positioned on the bottom wall with the bottom vent layer extending through the bottom susceptor layer. The top susceptor layer is positioned on the top wall. The side susceptor layer is positioned on at least one of the plurality of side walls. The absorbent material is positioned adjacent the bottom vent opening.

In some forms, each of the walls of the package includes a vent opening.

According to some forms, each of the walls of the package includes a susceptor layer.

In accordance with some forms, different patterning of susceptor materials may be positioned on different walls, such as 100% patterning on the top and bottom walls with less than 100% patterning on the side walls.

According to some forms, the top and bottom walls are configured to contact the food product while the sides walls do not contact the food product and have less than 100% susceptor material to reduce transmission of microwaves to the sides of the food product.

In some forms, the corners of the bottom wall do not include susceptor material.

According to some forms, the absorbent material is positioned on an interior side of the bottom wall.

In some forms, the absorbent material is positioned on an exterior side of the bottom wall.

According to some forms, the absorbent material is positioned within the bottom wall.

In some forms, the absorbent material is selected from the group consisting of cotton, paper, cellulose, and the like, and combinations thereof.

According to some forms, the absorbent material extends beyond a periphery of the bottom vent opening.

In some forms, the bottom susceptor layer is 100% patterned and the side susceptor layer is about 50% patterned to about 85% patterned.

According to some forms, the bottom wall defines a plurality of vent openings.

In some forms, at least one of the top wall and the at least one side wall defines a second vent opening.

According to some forms, the package further includes a comestible contained within the comestible cooking space.

In some forms, the comestible is a sandwich.

Further, a making a microwavable package is provided in which a blank is provided having one or more of the features described above.

### BRIEF DESCRIPTION OF THE DRAWINGS

Disclosed herein are embodiments of systems, apparatuses and methods pertaining to microwavable packages and food items. This description includes drawings, wherein:

FIG. 1 is perspective view of a food package.

FIG. 2 is a front perspective view of the food package of FIG. 1.

FIG. 3 is a front perspective view of the food package of FIG. 1 with the lid in an open configuration.

FIG. 4 is a top perspective view of the food package of FIG. 3 showing the internal susceptor features.

FIG. 5 is a bottom view of the food package of FIG. 1.

FIG. 6 is a bottom view of another food package and absorbent material.

FIG. 7 is a top view of a portion of another food package with vent openings.

FIG. 8 is a side view of the food package of FIG. 7.

FIG. 9 is an inside view of a lid of the food package of FIG. 7.

FIG. 10 is a view of a blank used to form the food package of FIG. 1.

FIG. 11 is a cross-sectional view of one configuration of a bottom structure of a food package.

FIG. 12 is a cross-sectional view of another configuration of a bottom structure of a food package.

FIG. 13 is a cross-sectional view of another configuration of a bottom structure of a food package.

FIG. 14 is a top view of another form of food package in a partially disassembled form.

FIG. 15 is a perspective view of the package of FIG. 14 in a folded form.

FIG. 16 is a perspective view of the package of FIG. 14.

FIG. 17 is a top view of the package of FIG. 14.

FIG. 18 is a top view of a card.

FIG. 19 is a bottom view of the card of FIG. 18.

FIG. 20 is a top view of the package of FIG. 14 combined with the card of FIG. 18.

FIG. 21 is a perspective view of another form of food package.

FIG. 22 is a top view of the package of FIG. 21.

FIG. 23 is a perspective view of the package of FIG. 21 illustrating a tapered shape.

FIG. 24 is a top view of a partially exploded view of another form of food package.

FIG. 25 is a perspective view of the package of FIG. 24 in a partially assembled form.

FIG. 26 is a perspective view of the package of FIG. 24 in a partially assembled form.

FIG. 27 is a front perspective view of the package of FIG. 24 in a partially assembled form.

FIG. 28 is a front perspective view of the package of FIG. 24 in an assembled form.

FIG. 29 is a top view of a food package with a smaller susceptor on a bottom surface.

FIG. 30 is a top view of a food package with an embossed bottom surface.

FIG. 31 is a side profile of the embossed bottom surface of the package of FIG. 30.

FIG. 32 is a cross-sectional view of a food package having multiple susceptor layers.

FIG. 33 is a bottom view of a top wall having one or more creases, perforations, and/or partial cuts.

FIG. 34 is a bottom view of a top wall in the form of a lid having a flap with openings.

FIG. 35 is a top view of a food package prior to assembly.

FIG. 36 is a perspective view of the food package of FIG. 35 with the lid open.

FIG. 37 is a rear perspective view of the food package of FIG. 35 with the lid closed in a first height configuration.

FIG. 38 is a front perspective view of the food package of FIG. 37.

FIG. 39 is a rear perspective view of the food package of FIG. 37 with the lid closed in a second height configuration.

FIG. 40 is a side perspective view of the food package of FIG. 39.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, convenient, microwavable packages for cooking and crisping food products, such as grilled cheese sandwiches, other sandwiches, pizzas, flatbreads, and the like, in a microwave oven, are described herein. In some forms, the microwavable packaged food product includes an outer package and a quantity of comestible or food product contained therein, where the packaged food product may be heated in a microwave oven. By one approach, the package has one or more side walls, a bottom wall, and a top wall or lid. The package includes at least one susceptor layer that includes a microwave energy interactive material thereon as well as at least one vent opening therein. Further, the package may include an absorbent material, such as an absorbent pad having at least one material for absorbing moisture and/or grease. In this manner, a microwavable package or carton can be provided that generally surrounds the contained food product with the one or more susceptors providing crisping and/or heating functionality when used in a microwave. Since the package can include a lid that may somewhat restrict moisture migration compared to other more open packages, the absorbent material can be used to absorb moisture that is generated, such as through the bottom of the package. This can help decrease the bottom of the food becoming soggy. Further, in some forms, the bottom wall and lid contact the food product to help crisp the top and bottom surfaces. The side walls may be positioned such that there is a non-contact space between the side walls of the package and the food product.

In one illustrative approach, the susceptor is a metallized poly-film laminated to a base layer, such as to a paper layer with a poly-layer. More specifically, in one example the susceptor layer includes a multilayer flexible structure having at least a product-contacting layer with a metallized material having the microwave energy interactive material thereon and a paper layer (which may include additional paper or poly-layers for functionality). In another example, the multilayer flexible structure of the susceptor layer further includes an additional polymer layer.

The absorbance is a function of the susceptor material as well as the thickness and pattern. Accordingly, a desired absorbance can be achieved by combinations of material, thickness, and pattern. Thus, each of the susceptors can be made to have a predetermined absorbance characteristic needed for a particular food and/or position relative to the food.

The package may also include multiple susceptor layers positioned at various locations in the package. For example, if the package includes a bottom, four sides, and a top or lid, susceptors may be positioned on the inside of each of these surfaces. Further, different types of susceptor materials may be positioned on the different surfaces where the susceptors can be 5% to 100% patterned on one or more of the surfaces, representative of the amount of susceptor material to non-susceptor material of the susceptor area. For example, the side surfaces may have a susceptor with 50% to 85% patterning of susceptor material on the susceptor area to provide less intense heating and/or crisping to the side surfaces of the food. The top and bottom surfaces may have a more complete susceptor, such as having 100% patterning of the susceptor area. In some forms, the top and bottom surfaces include 100% patterned susceptors while the side walls include less than 100% patterned susceptor areas, such as less than 90%, less than 85%, less than 80%, less than 75%, less than 70%, less than 65%, and the like. In addition to the patterning, it should be appreciated that less than an entire wall surface may be covered with the susceptor area. For example, approximately 90% of a wall surface area may be covered by susceptor patterning and the patterned portion that is located on a wall may be 100% or less susceptor patterning.

The various susceptors may also have a variety of shapes and configurations including, but not limited to, circular, rectangular, oval, and the like. The susceptors may also be configured such that at least one of the susceptors contacts the food product while other susceptors do not contact the food product. For example, the top and bottom wall susceptors may be configured to contact the food while the sides are spaced from the food. Preferably, the shape of the susceptors is chosen to at least conform to the principal dimensions of the food product to be heated. However, as described in more detail below, one or more of these surfaces may include openings or vents. Additionally, or alternatively, the openings or vents may extend through the susceptors. These details will be described in more detail below.

The total susceptor surface area should be selected such that the susceptors do not generate too much heat inside the package when used in a microwave oven. For example, the glue and other adhesives should not melt or otherwise degrade such that the package loses structural integrity. This can be accomplished by selecting high temperature adhesives for the package or by adjusting the susceptor properties (area, optical density, patterning, and the like) or by a combination of both.

As suggested above, the susceptor material or layer may have a vent opening, perforations, holes, or other openings therein to facilitate draining of moisture and/or grease from the package. Further, in some configurations, the one or more vent openings may be positioned at the bottom wall or surface of the package. Additional vent openings may also be positioned on the bottom wall and/or any of the other walls, such as the top wall and side walls. The vent openings may take a variety of shapes and may vary depending on placement on the package. For example, in some forms, the vent openings are generally elongated. They can be circles, ovals, rectangles, as well as other shapes. It should be appreciated that, in some forms, one or more of the walls may not include any vent openings, perforations, holes, or other openings. For instance, one or more of the top wall, bottom wall, or side walls may be included without any openings.

The vent openings may also have a higher concentration of vent openings at different locations on the package. For example, there may be a higher concentration at a center of the microwavable package at the bottom wall. In one illustrative configuration, the discrete openings are disposed in a radial pattern or configuration emanating from the center of the susceptor layer on the bottom wall. In one exemplary embodiment, the various walls of the package may have a ratio of vented surface area to non-vented area of 25-75%, depending on the wall and overall size of the wall relative to the food product. Typically, however, the overall package does not have more than 50% of the overall surface area exposed from vent openings.

By having a pattern within these ranges, the food product is cooked and crisped by removing a certain amount of moisture and/or grease to avoid producing a chew and/or greasy result while also providing suitable heating/cooking. These ranges are particularly suitable for cooking sandwiches, such as grilled cheese sandwiches in a way that closely replicates pan cooked or grilled sandwiches.

It is believed that in some forms, depending on the food product, by providing walls generally enclosing the food area (except for the vent openings) the food product and various surfaces thereof can be suitably heated/cooked without becoming chewy. The vent openings also help moisture escape to avoid sogginess. In some forms, the combination of having all sides of the food product exposed to some form of susceptor along with vent openings placed at certain locations can provide desirable crispiness to the food product without becoming chewy. Further, in the case of certain food products, such as sandwiches, both the upper and lower portions of the food product contact susceptor layers on the top and bottom walls to provide desirable crispiness to the food product. Having susceptors, such as 75% patterned susceptors on the side walls, with non-contact space between the side walls and food product can also aid in providing a desired texture to the sides of the sandwich. For example, the non-contact space can result in sides of the sandwich not being too crispy.

In some embodiments, the vent openings may be formed via, for example, die cuts or laser cuts formed in the susceptor layer (and optionally the paperboard layer). In one illustrative approach, the vent openings are cut into the material before the susceptor layer is attached to the remainder of the package.

Similarly, one or more of the walls can include partial cuts, perforations, creases, and the like. These structures can help prevent the various walls from curling or excessively deforming during heating. It is believed that the heat and/or moisture can cause the walls to deform. This can be problematic, such as with the top wall, as the wall may move away from and no longer contact the food product, thereby not providing desirable crisping. The modifications to the walls can allow the susceptor to release moisture and decrease curling and deformation of the walls.

As noted above, the package includes a support layer, such as a paperboard layer, heat resistant plastics, and other microwavable materials. The support layer can be used to form a blank that is then used to create the package, such as having a plurality of sides, a bottom side, and the top side or lid. The paperboard is selected from material having sufficient mechanical properties to form a package or carton that can hold one or more comestible products. The support layer, such as paperboard, can have any desirable thickness to provide suitable support, depending on the size and weight of the food product. For example, in the case of grilled cheese sandwiches, 0.018 inch thick paperboard may be used. However, it should be appreciated that other thicknesses and strengths of materials may also be used. For example, material that is thicker than 0.018 inches and/or material that is thinner than 0.018 inches may be used alone or in combination with other thicknesses of materials.

As suggested above, in some configurations, the package can include an absorbent material positioned at various locations on the package. For example, the absorbent material can be positioned at one or more of the vent openings. In the case of a bottom vent opening, the absorbent material can be positioned about the bottom vent opening such that the absorbent material covers the vent opening and extends at least to the periphery of the vent opening. The absorbent material may be placed on an inside surface, outside surface, or within the vent opening, such as in the case of a laminate of layers used to form the wall.

The absorbent material can take a variety of different forms including, but not limited to coatings, layers, pads, combinations of layers, and the like. The absorbent material can include one or more of a variety of different absorbing and non-absorbing materials. The non-absorbing materials can be used as long as one absorbing material is used in the layer. For example, a hydrophobic coating may be used on certain portions to help cause moisture to migrate within and/or along the absorbent material/layer. The absorbent material can include, but is not limited to, cellulose, paper, cotton, and the like, and combinations thereof. The thickness of the absorbent layer can also be modified depending on the type of food product, side of the food product, amount of moisture generated when the food product is heated in the microwave, and the like. In one form, such as with a grilled cheese, the absorbent material can have a thickness of about 0.8 mm of cellulose. Other materials, thicknesses, and configurations of the absorbent layer may also be used. For example, material that is thicker than 0.08 mm and/or material that is thinner than 0.08 mm may be used alone or in combination with other thicknesses of materials.

The order of the layers for the food package may vary, though the susceptor layer is generally disposed on the food-facing and/or food-contacting surfaces of the package. In addition, the size of the layers may vary with respect to one another. By one approach, the susceptor layer, the absorbent material, and the package sides are coextensive with one another. By yet another approach, the susceptor layer covers less surface area of the package sides. In some forms, the absorbent material may be disposed only underneath the vent openings. In another example, the absorbent material may be disposed coextensive with the susceptor layer and/or the paperboard layer. In another configuration, the paperboard base layer of the microwavable support layer extends beyond the perimeter of the susceptor layer such that a consumer can grasp the paperboard base layer without touching the susceptor layer. In some configurations, the susceptor layer covers less surface area of the microwavable support than the paperboard base layer. This also permits the perimeter portions of the paperboard base layer to be used for safe handling by the consumer when removing it from the microwave oven, because the area on the edges remains comparatively cooler.

The packages outlined herein provide a quick manner of cooking and crisping foods such as sandwiches and the like in the microwave oven with minimal mess by having at least one susceptor permitting quick and even cooking of sandwiches (or other foods), one or more vent openings, and an absorbent material for managing any moisture, oils, grease, and the like that are a byproduct of the cooking operation. In short, the combination of these elements is configured to balance the removal of moisture and/or grease while providing sufficient crisping of the food product. The packages herein may be particularly attractive to consumers who wish to enjoy foods such as grilled cheese sandwiches, other sandwiches, and flat breads (or other food products which may produce moisture, oil or grease during the cooking process), but want the convenience of a microwavable serving of such a food product.

A variety of comestibles or food products may be heated using the microwavable packages described herein. For example, the food product may comprise sandwiches (such as grilled cheese, hot ham and cheese, and other grilled sandwiches), snacks, appetizers, frozen ethnic cuisines (taquitos, quesadillas, burritos, etc.), flatbreads (such as pita bread, crepe, tortilla, focaccia, piadina, naan, chapati, lavash, roti, pancake, blintz, lafa, aish mehahra, barbari bread, bazlama, bhakri, bhatura, bing, flammkuchen bread, flatkaka, injera, laobing, laxoox, lefse, luchi, malooga, markook, ngome, papadum, paratha, pide, rieska, sangak, tunnbrod, yufka, galette), panini bread (which could consist of French bread, sourdough bread, ciabatta, or other related forms of leavened or unleavened bread), biscuits, English muffins, breakfast sandwiches, potato products (hash browns, tater tots, French fries, and the like), muffins, crumpets, scones, shortcake, waffles, pastries, croissants, pizza, calzones, stromboli, garlic bread, bagels, baguettes, hamburger rolls, hot dog rolls, breadsticks, Brioche, French toast, pocket sandwiches (fillings encased in a bread/dough), quiche and other pastry or pie crusts.

Ordinarily, the width and length of the package cavity or cooking space exceed the nominal predetermined dimensions of the food product to accommodate variations in the nominal dimensions that occur during production and so that the food product is fully supported. Typically, the food product is about 1 inch to about 1.75 inches thick. However, the package can be modified to accommodate larger and/or smaller food products. In some forms, the food product contacts the bottom surface or wall, such as the bottom susceptor, and may contact one of more of the other walls, such as the top wall or side walls. In some forms, the food product only contacts the bottom wall such that the food product is spaced from the top wall and side walls. In some forms, the food product contacts the bottom wall and the top wall as well as the corresponding susceptors.

Preferably, the food product is fully and/or partially cooked so that the food product is only partially cooked and/or heated using the package described herein. In some forms, the food product is fully cooked and is heated using the package.

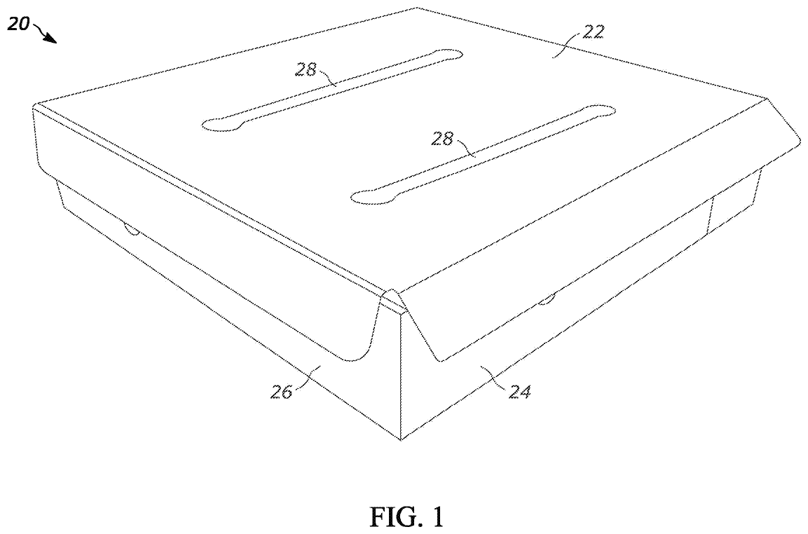

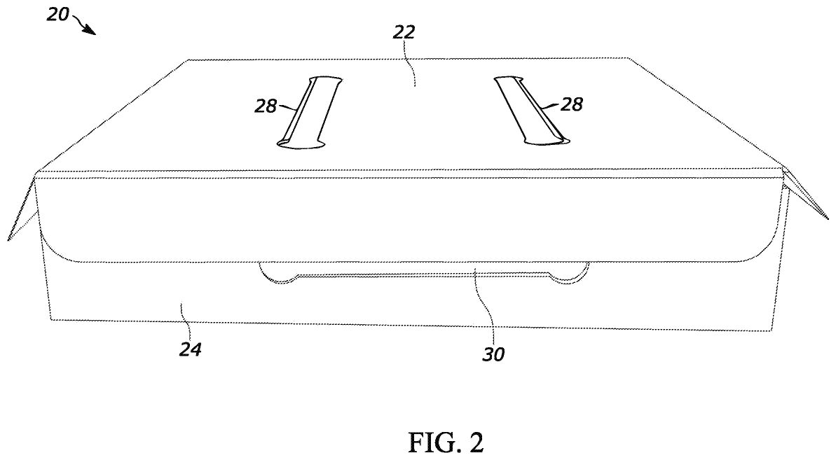

Further details regarding the concepts described herein will be made with reference to the figures. For example, as found in FIG. 1, a package 20 is shown having a top wall 22, such as a lid, and side walls 24,26. The top wall 22 includes two vent openings 28 where the openings 28 extend from an inside surface to an outside surface through the top wall 22. As seen in FIG. 2, the side wall 24 also can include a vent opening 30.

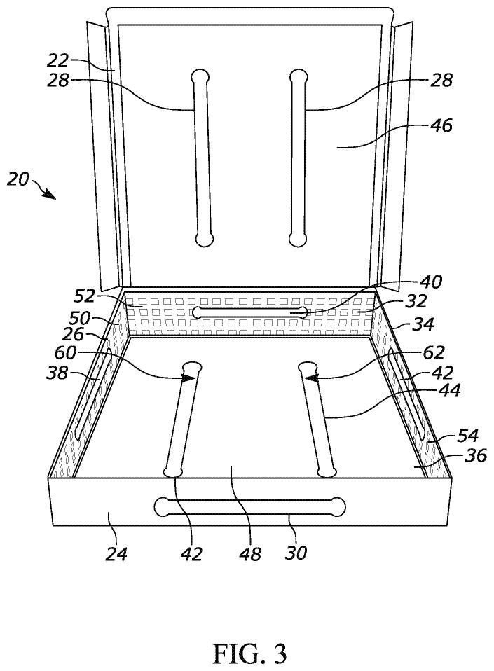

Turning to FIG. 3, the inside of the package 20 is illustrated. In addition to side walls 24,26, the package includes side walls 32,34 as well as bottom wall 36. Side walls 26,32,34 include vent openings 38,40,42 while bottom wall 36 includes vent openings 44. As noted above, the number, size, shape, placement, and the like of the vent openings can be varied, as desired. In some forms, only a single vent opening 44 is included in the bottom wall 36 and no additional vent openings are included in any of the other walls. In other forms, multiple vent openings may be placed in various locations on a single wall, such as in the form of a plurality of discrete vent openings. In some forms, the side vent openings extend approximately 1.5-3 inches and have a width of about ⅛-½ inch. In some forms, the top and bottom vent openings have a length of about 2.5-3.5 inches and a width of about ⅛-½ inch. However, it should be appreciated that other sizes may also be used depending on factors such as the food product, overall dimension of the package, and other factors. The vent openings may also extend entirely through the respective wall or at least partially through the wall, such as to an absorbent material that is positioned within the wall.

Package 20 also includes a variety of susceptor layers and types of susceptors. For example, top wall 22 may include susceptor 46 while bottom wall 36 includes susceptor 48. The side walls 26,32,34 may also include susceptors 50,52,54. Side wall 24 may also include a susceptor, but it is not shown in the figures. While susceptors can be included on all of the interior surfaces facing the food product and cooking space, it should be appreciated that in some forms only a single susceptor may be included, such as on the bottom wall 36. Additionally, the different walls can include different forms of susceptors. For example, susceptors 46,48 are generally 100% patterned susceptors. On the other hand, susceptors 50,52,54 are 75% patterned susceptors. Depending on factors such as the type of food product, the susceptors on the side walls may be about 50% patterned to about 85% patterned. Other combinations of different patterns, sizes, optical densities, and the like can be included.

As found in FIG. 3, the package 20 can also include an absorbent material 60,62 positioned about one or more of the vent openings. The absorbent material 60,62 is shown as being positioned on an outside surface of the bottom wall 36, away from the cooking space. However, it should be appreciated that the absorbent material 60,62 can be positioned on an inside surface of the bottom wall 36 as well as positioned as an internal layer relative to the bottom wall 36.

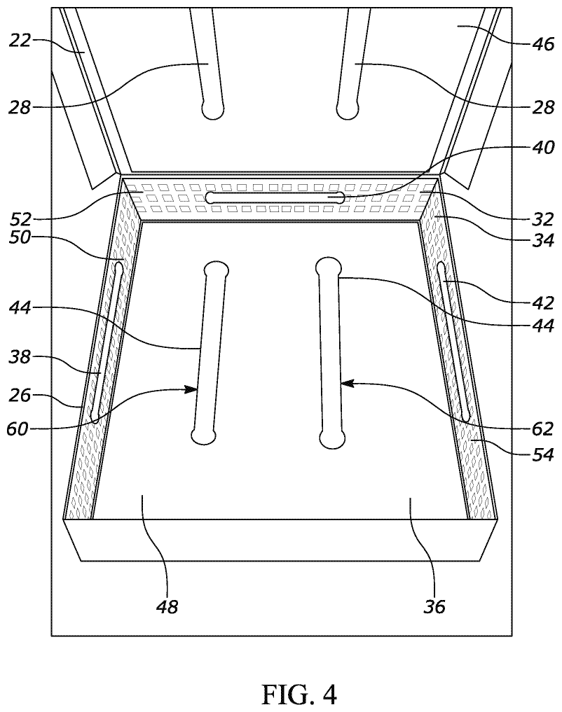

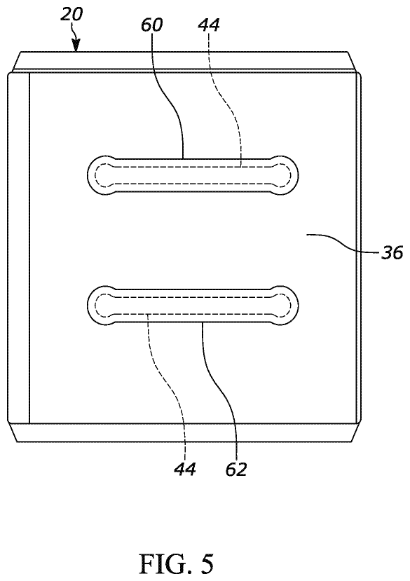

Turning to FIG. 5, the underside of the package 20 is shown. As seen in this view, the absorbent material 60,62 is positioned about the vent openings 44 such that the absorbent material extends beyond the periphery of the vent openings 44 to substantially encircle the openings. It should be appreciated that absorbent material 60,62 is shown as separate components in this figure, but can instead be a single material or layer. In this regard, the absorbent material can be a single material that covers both vent openings 44 and then extends to the periphery of the bottom wall 36 or less than the periphery of the bottom wall.

The absorbent material can be configured such that at least some of the moisture generated within the package may be absorbed and otherwise transferred away from the food product during heating. For example, when the absorbent material is included at the bottom vent opening, the absorbent material can help remove moisture from the underside of the of the food product. In some forms, simply having bottom vent openings may be sufficient to allow moisture to escape from underneath the food product. In other forms, it may be beneficial to include the absorbent layer so that moisture is pulled away from the bottom of the food product. This can be especially helpful when the package is placed directly on the bottom of the microwave such that moisture is less able to escape from underneath the food product. In other words, the absorbent material can help facilitate moisture transfer away from the bottom of the food product even if the package is set directly on the bottom of the microwave.

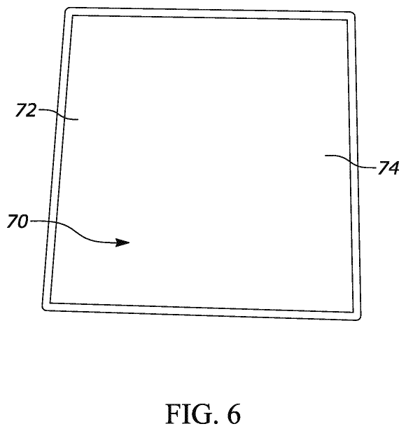

A further form of package 70 is shown in FIG. 6. In this form, the package 70 includes a bottom wall 72 with an absorbent material 74. As seen in this form, the absorbent material 74 is in the form of a layer that extends nearly to the periphery of the bottom wall 72. The absorbent material 74 can be attached, such as by gluing, near the periphery of the bottom wall 72. The absorbent material 74 may also be adhered at other locations, such as closer to the center of the bottom wall 72 and near the vent openings (not shown).

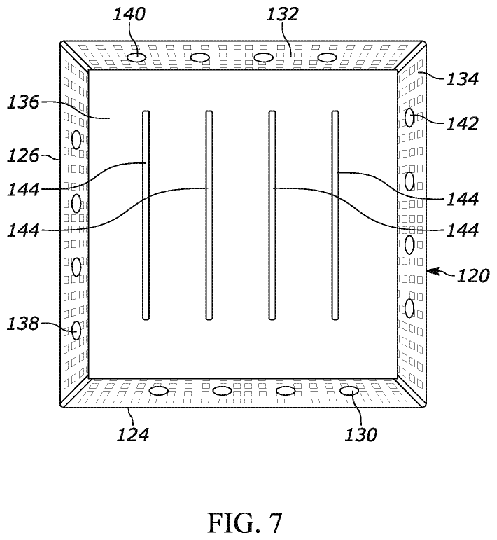

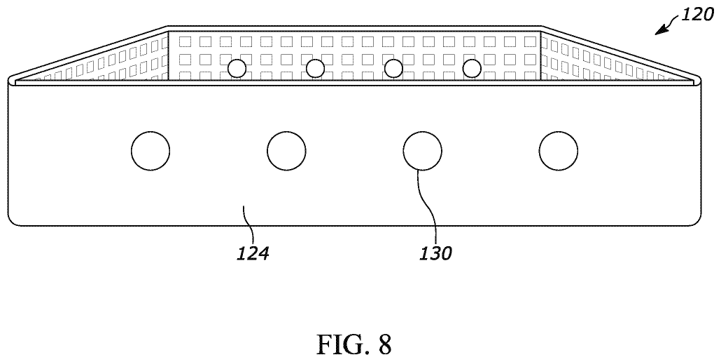

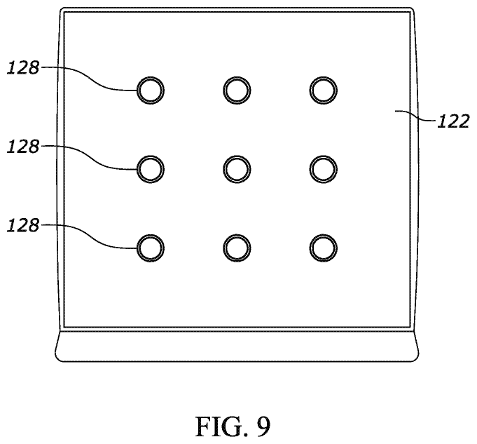

FIG. 7 illustrates another form of package 120. The package 120 includes a number of features similar to those found in the embodiment shown in FIG. 3. Many of these features will not be discussed in detail, but should be understood from the descriptions provided above. However, the form found in FIG. 7 includes a number of different features, such as the shape, number, and placement of the vent openings. For example, bottom wall 130 includes four elongate vent openings 144. Similarly, each of side walls 126,130,132,134 include a plurality smaller circular vent openings 138,140,142,144. As shown in FIG. 9, the top wall 122 can include a plurality of smaller circular vent openings 128, such as in a 3×3 configuration. In other words, the number and shape of the vent openings can be modified, as desired. In this form, the susceptors are generally similar to the susceptors described above regarding FIG. 3, but they can be modified, as desired.

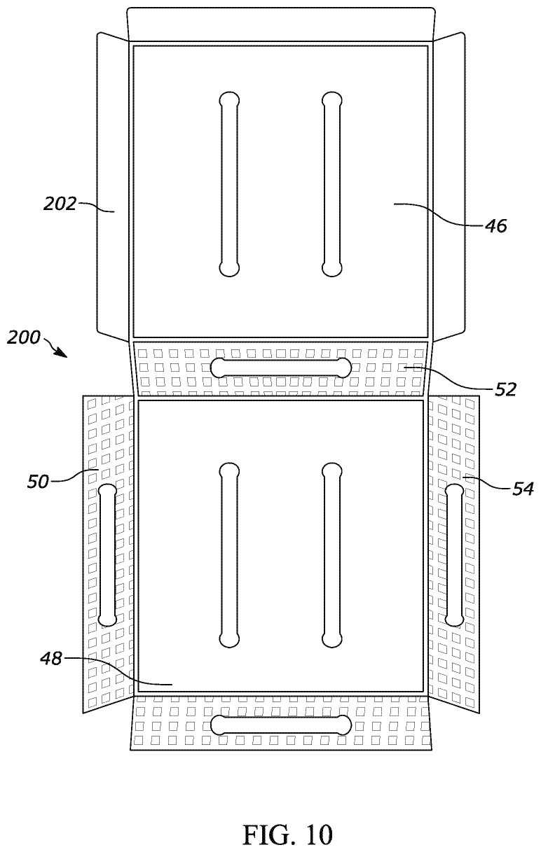

A blank 200 is shown in FIG. 10. The blank can be used to form any of the packages described herein. In one form, such as shown in FIG. 10, the blank 200 can be used to form the package 20. The blank can be formed using a support material 202, such as paperboard. The various susceptors can be adhered, glued, and the like to eh support material 202. The various vent openings can also be installed, such as by cutting and the like, described above. The order of combining the support material 202 with the susceptors and forming the vent openings can be modified as needed. For example, in some forms, the susceptors are added prior to forming the vent openings. In other forms, the vent openings can be formed prior to the susceptors being added. In this form, the susceptors may include pre-formed vent openings before being combined with the support material 202.

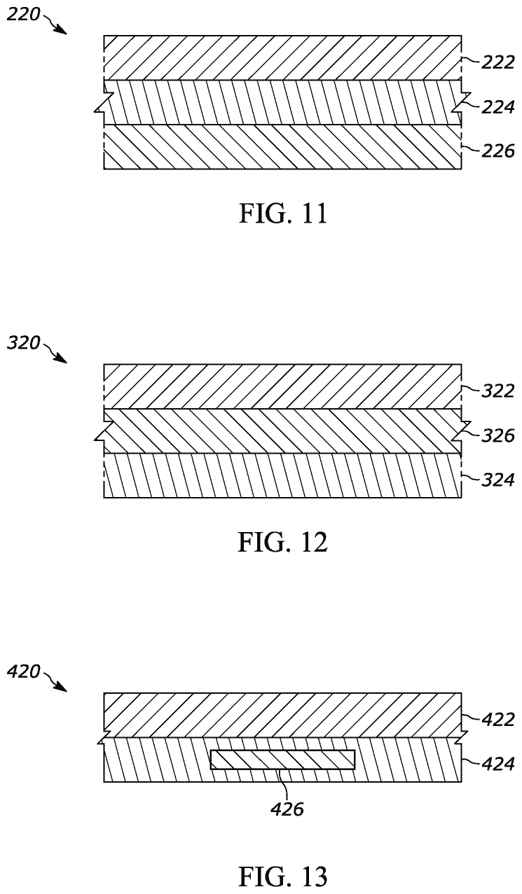

Cross-sectional views of various bottom wall configurations are shown in FIGS. 11-13. As found in FIG. 11, the bottom wall 220 includes susceptor 222, support material 224 and absorbent material 226. In other words, in this configuration, the absorbent material 226 would be positioned on an exterior surface of the support material 224.

FIG. 12 shows cross-section of an alternative configuration. In this form, bottom wall 320 includes susceptor 322 and support material 324 with absorbent material 326 positioned therebetween. A vent opening may be positioned at susceptor 322 and at support material 324, but the absorbent material 326 may not have a vent opening extending therethrough. In this form, the absorbent material could contact the moisture and wick the moisture away from the openings in the susceptor 322 and support material 324.

A cross-section of yet another form is shown in FIG. 13. In this form, absorbent material 426 may be positioned as an internal layer of support layer 424. Susceptor 422 would be placed on the support material and include a vent opening therein. The support material 424 may include other smaller vent openings so as to permit moisture to contact the internal absorbent material 426.

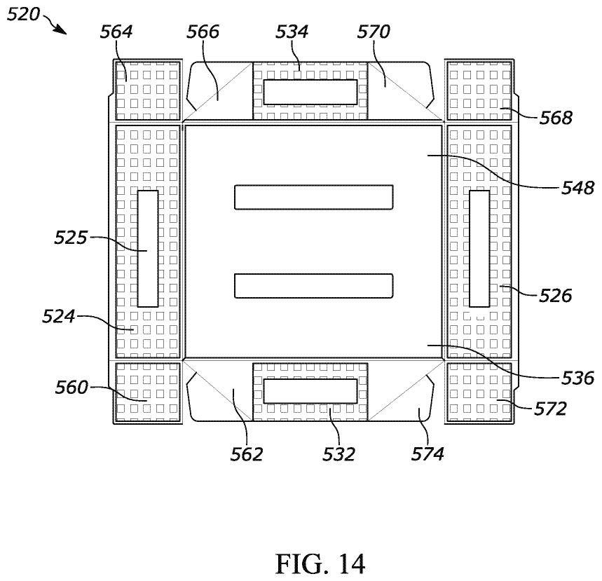

Yet another configuration is shown in FIGS. 14-20. This configuration may or may not include an absorbent material, as described above, to form part of the layers used in package 520. An exploded/partially disassembled view of package 520 is shown in FIG. 14. Package 520 may include a variety of the features discussed above. For example, package 520 may include a bottom wall 536 as well as side walls 524,526,532,534. The various walls can include susceptors, as desired, including different susceptors having different patterning and/or optical densities. For example, susceptor 548 can be 100% susceptor while the side walls can include a different amount of susceptor, such as 50% patterning. Additionally, the package 520 can include various vent openings 525, as shown in FIGS. 14-20. The number, size, position, etc. of the vent openings 525 can be varied, as discussed previously. The vent openings 525 can provide the same benefits and function as alternative designs discussed above.

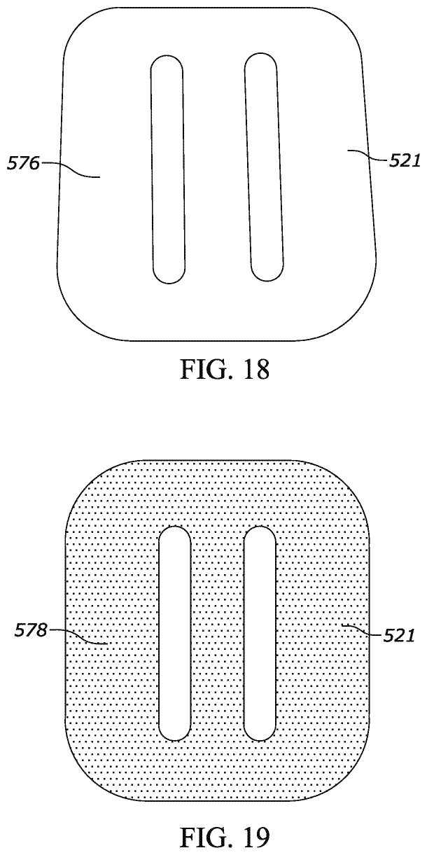

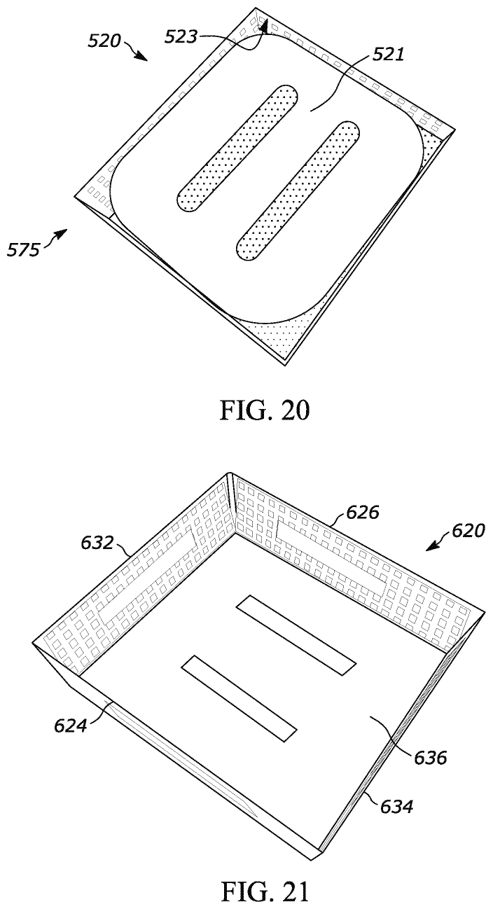

The package 520 may also include a removable card 521, as shown in FIGS. 18 and 19. In this form, the removable card replaces a top wall of the package 520 such that the contents of the package 520 can be accessed via an opening 523. In other words, package 520 is a top load format whereby the card 521 can be positioned in the opening 523 and on top of a food product, such as shown in FIG. 20.

The package 520 can be glued and folded for shipping, storage, and the like prior to inserting a food product therein. As shown in FIG. 15, a glued form of the package 520 is partially folded where portions of one or more of the side walls 524,526,632,534 is folded. In this regard, as shown in FIG. 14, portions of the side walls 524,526,632,534 may be adhered to one or more of the other of the side walls 524,526,632,534. For example, portion 560 is secured to portion 562, while portion 564 is secured to portion 566. Similarly, portion 568 is secured to portion 570 and portion 572 is secured to portion 574. In this regard, the corners can be tucked such that the package 520 is generally flattened. The corners can then be pulled open to form a tray portion 575. As shown in FIG. 14, portions 560,564,568,572 are all positioned inwardly and include susceptor material thereon. In one form, this susceptor material may be 75% susceptor, though other susceptor and patterning can be used.

As noted above, the package also includes removable card 521, as shown in FIGS. 18 and 19. In one form, the removable card 521 is a separate component and is not connected to any of the side walls 524,526,632,534. The removable card 521 includes an upper surface 576 and a lower surface 578. In one form, the lower surface 578 includes can include susceptor material thereon, such as 100% susceptor material. It should be appreciated that other amounts and patterning of susceptor material may be used. Further, as shown in FIG. 19, the susceptor material covers the entire lower surface 578, but less than the entire surface may be covered.

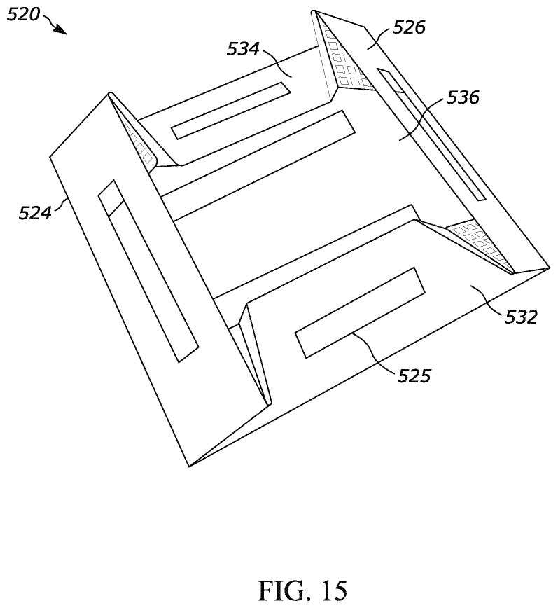

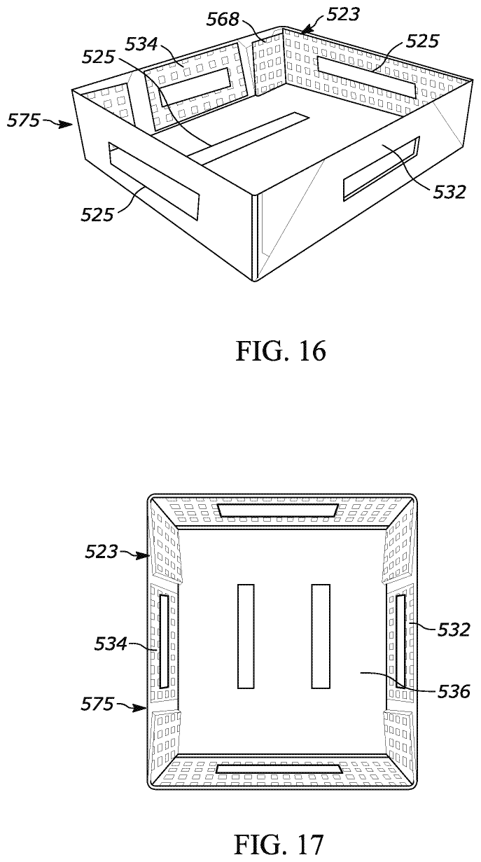

After the tray is formed, a food product is placed in the tray portion 575 shown in FIGS. 16 and 17 and the removable card 521 is placed on the food product. The card 521 can rest on top of the food product and maintain contact with the top of the food product to ensure the food product is crisped when cooked. One form, including a sandwich, is shown in FIG. 20. The edges of the tray extend past the sandwich to ensure the card rests within the tray portion 575 and does not get displaced through shipment and handling. This also allows the card to maintain contact with the bread as the contents of the sandwich change (cheese, pepperoni, bacon, etc.).

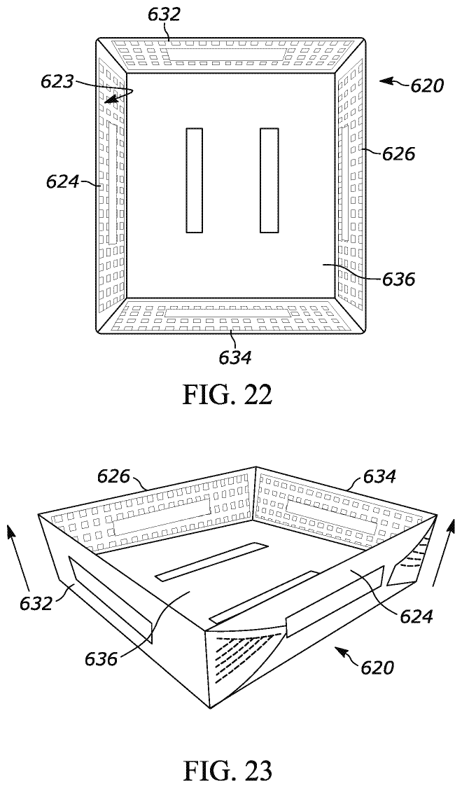

Another configuration is shown in FIGS. 21-23. Package 620 includes similar features to those discussed above, such as with respect to FIGS. 14-20 and will not be repeated here. However, package 620 includes a generally tapered structure at one or more of the side walls. For example, one or more of side walls 624,626,632,634 may extend at an obtuse angle relative to bottom wall 636. As best seen in FIG. 23, each of the side walls 624,626,632,634 extend at an obtuse angle relative to the bottom wall 636 such that the side walls 624,626,632,634 extend outwardly from the dimensions of the bottom wall 636. In other words, opening 623 has a greater area than an area of the bottom wall 636. It should be appreciated that package 620 can also include a removable card, similar to what is shown in FIGS. 18-20. Further, the side walls 624,626,632,634 can be glued in a similar manner as described with respect to FIGS. 14-17. However, instead of folding, package 620 can be stored in a nested arrangement with other packages prior to having a food product placed therein.

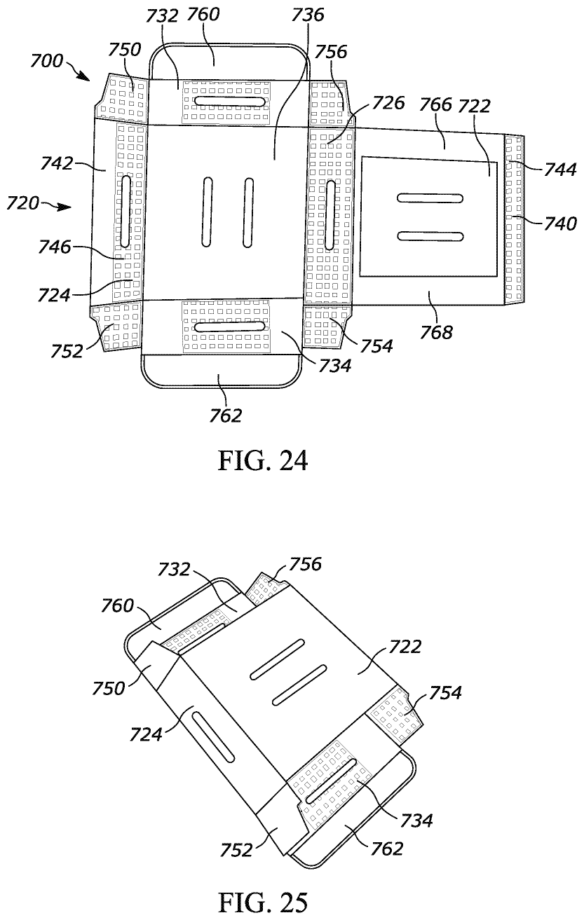

Yet another configuration is shown in FIGS. 24-28. Package 720 is generally considered a double tuck configuration whereby two ends of the package 720 include foldable and closable side walls. The package 720 can include many of the features discussed above, such as varying susceptors, vent openings, absorbent layers/materials, and the like. These features are not discussed in detail here for the sake of brevity but should be appreciated as being included, such as shown in the figures and understood from the above descriptions of these features.

Turning to FIG. 24, a partially disassembled configuration is shown, such as in the form of a blank 700 that is later glued to form the package 720. As shown in FIG. 24, the package 720 includes top wall 722 side walls 724,726,732,734, and a bottom wall 736.

Various portions of the package 720 can be adhered together. For example, portion 740, connected to top wall 722, can be adhered to portion 742 of side wall 724. In this regard, when secured, portion 740 will be folded and positioned along side wall 724 such that susceptor 744 is generally contiguous with and extends along the same plane as susceptor 746 of side wall 724.

The package 720 may also include various flaps, that can also include susceptor, to generally surround food products contained within the closed package 720. For example, flaps side wall 724 includes flaps 750 and 752 while side wall 726 can include flaps 754 and 756. The flaps 750,752,754,756 can extend outwardly, as shown in FIG. 25, but can be folded inwardly, as shown in FIG. 27. As seen in the figures, the flaps 750,752,754,756 can include various susceptor materials as the flaps otherwise cover portions of the side walls 732,734 when folded inwardly. In this form, susceptor material may continue being positioned around food in the package 720, even when the flaps are folded.

Similarly, side wall 732 includes flap 760 while side wall 734 includes flap 762. Flaps 760,762 may also extend outwardly, as shown in FIG. 25, but also may be folded inwardly to enclose food in the package 720. The flaps 760,762 may also include susceptor material so that when the flaps 760,762 are folded inwardly, susceptor material may still surround the food. As shown in FIG. 24, portions 766,768 of top wall do not include susceptor material as this is generally the location where flaps 760,762 will be positioned when folded inwardly.

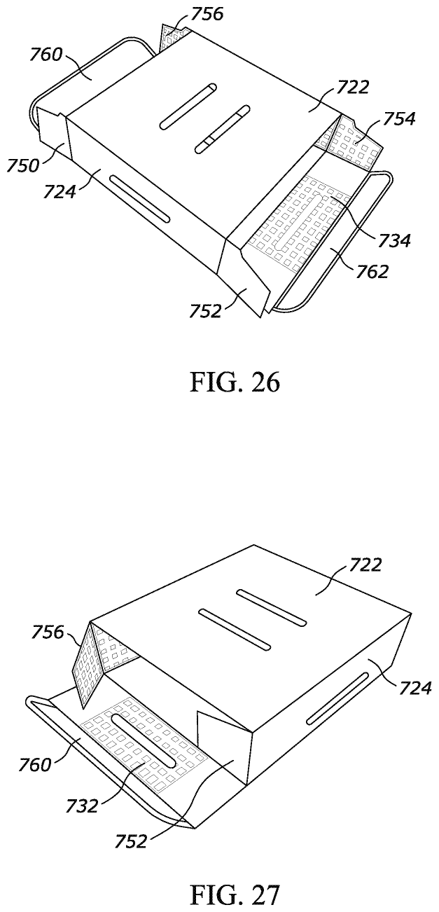

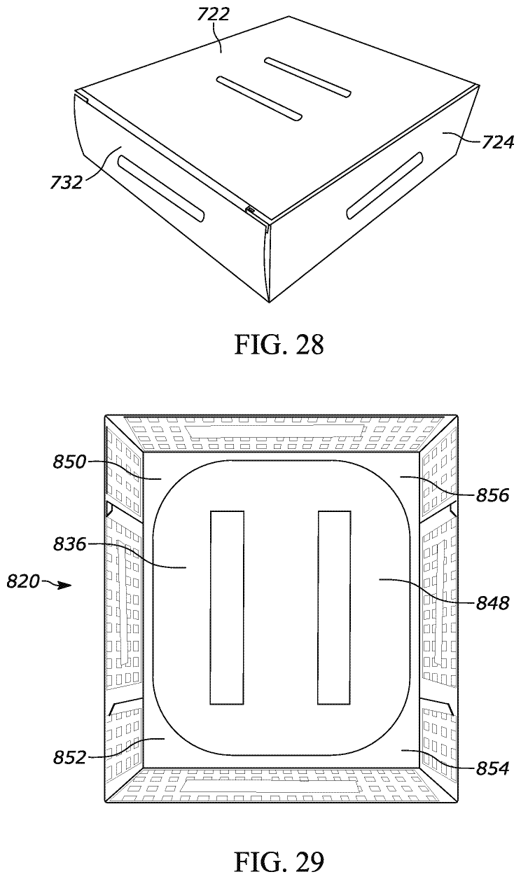

FIG. 25 illustrates package 720 as it is being manipulated from a generally flat configuration towards an open configuration, shown in FIG. 26. Similar to FIG. 25, the package 720 may be shipped generally flat and then pivoted so that the top wall separates from the bottom wall to permit food to be inserted into the package. One end of the package 720 can be folded inwardly prior to or after inserting a food product into the package. FIG. 27 illustrates where side wall 734 is rotated inwardly and flap 762 generally helps enclose the end. FIG. 28 illustrates a fully closed configuration where both ends of the package have been closed. As shown in FIG. 28, side wall 732 has also been rotated such that flap 760 has been inserted into an interior space of the package 720. In some forms, the closed configuration shown in FIG. 28 is used to cook the food product so that susceptor materials are generally positioned on all sides of the food product.

Another example of susceptor positioning is shown in FIG. 29. Package 820 includes a lower wall 836 with susceptor 848. As shown in this figure, susceptor 848 is positioned such that portions of lower wall 836 do not include susceptor material. For example, corners 850,852,854,856 are all exposed and do not include susceptor material.

Due to the high temperatures that are observed with some susceptor packaging after heating in the microwave, design features can be added to aid with handling. In FIG. 29, the corners 852,852,854,856 of the bottom wall 836 create an area with less heat for consumers to handle the package 820 after microwaving. This concept can also be applied to the card, lid, and/or to the sides of the tray to permit areas that are cooler for gripping.

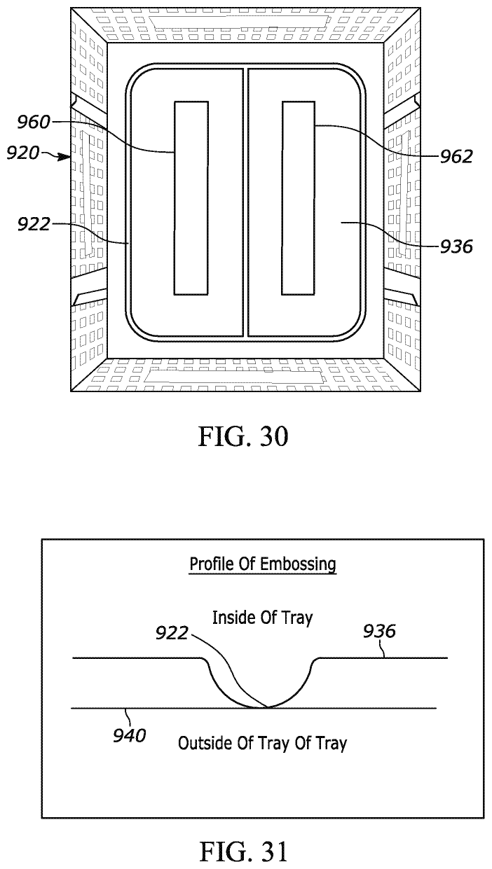

A modified form of a package is shown in FIGS. 29 and 30. In this form, package 920 includes an embossed portion 922 of the package 920 so as to help with air flow. More specifically, in one form, the embossed portion 922 can be positioned at the bottom wall 936 so as to raise the bottom wall 936 off the below surface and help permit air and/or moisture to escape and/or enter the package 920. A side profile is shown in FIG. 31 whereby the embossed portion 922 raises other areas of bottom wall 936 off of lower surface 940. This could then help air and/or moisture circulate through openings 960,962 in the bottom wall 936. In some exemplary forms, the embossing can range from 1/32″ to ⅛″, though other embossing may also be used. It should be appreciated that the embossed portion can be incorporated into any of the embodiments described herein.

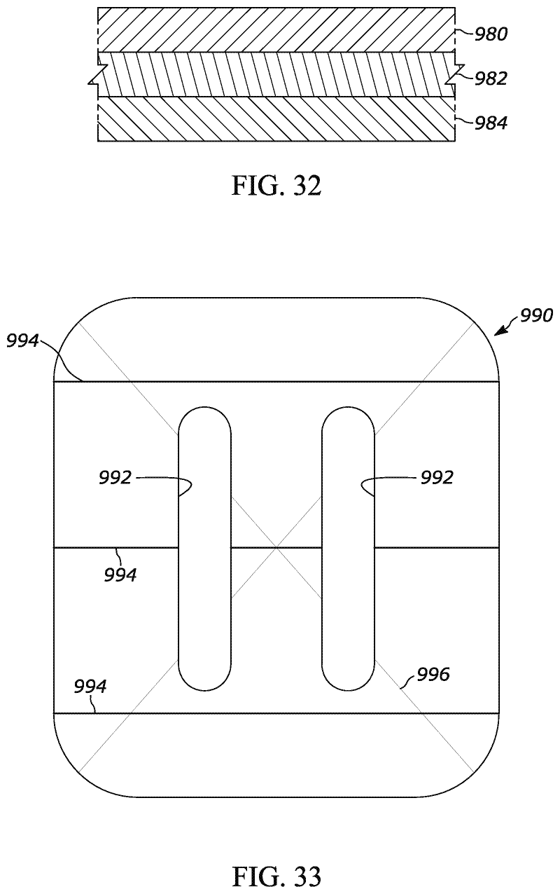

A further configuration of layers, including multiple susceptor layers, is shown in FIG. 32. In this configuration, a first susceptor layer 980 is used in combination with a second susceptor layer 982 positioned below the first susceptor layer 980. These multiple susceptor layers 980,982 can then be combined with additional layers, such as support layer 984. Any number of susceptor layers can be used in combination and including varying amounts of susceptor material. For example, one layer may be 100% susceptor material whereas another layer may be patterned with 50% susceptor material.

Increasing the amount of susceptor layers can increase heat delivery and improve crisp. As noted above, two susceptor boards can be laminated together to increase the amount of heat delivered to the product. Double susceptor lamination can increase susceptor temperatures 30-50 degrees F. In some forms, multiple susceptor layers may be especially useful on the top and bottom of the package to increase crisp, such as on the faces of bread. In some forms, depending on the food product, multiple susceptor layers may not be useful on the side of the package as this could increase toughness, such as to the crust of the bread.

Referring to FIG. 33, one form of a top wall 990 is shown. In this form, the top wall 990 is a card that is completely separate from a bottom wall and side walls. The top wall 990 includes vent openings 992 as well as modifications to the structure of the top wall 990. More specifically, the modifications can include creases, perforations, scores, partial cuts, and the like. For example, the top wall 990 includes creases 994 and partial cuts 996 in one or more of a top and bottom surface of the top wall 990. The modifications can take a variety of shapes, locations, and configurations. For instance, the partial cuts 996 are in an “X” shape.

The modifications are made to help minimize deformation of the package, such as the top wall 990 during heating. Deformation may occur from heat, moisture, and the like. For example, the packaging may be frozen, thawed, microwaved, and the like such that these temperature changes can cause the top wall 990 to curl. The modifications can permit moisture to release or otherwise migrate through the susceptor to decrease deformations of the walls. It should be appreciated that similar modifications can be located on other walls in the packaging. Further, an outer surface of any of the walls of the package may be uncoated to absorb moisture, especially when an inner side of the respective wall includes susceptor material.

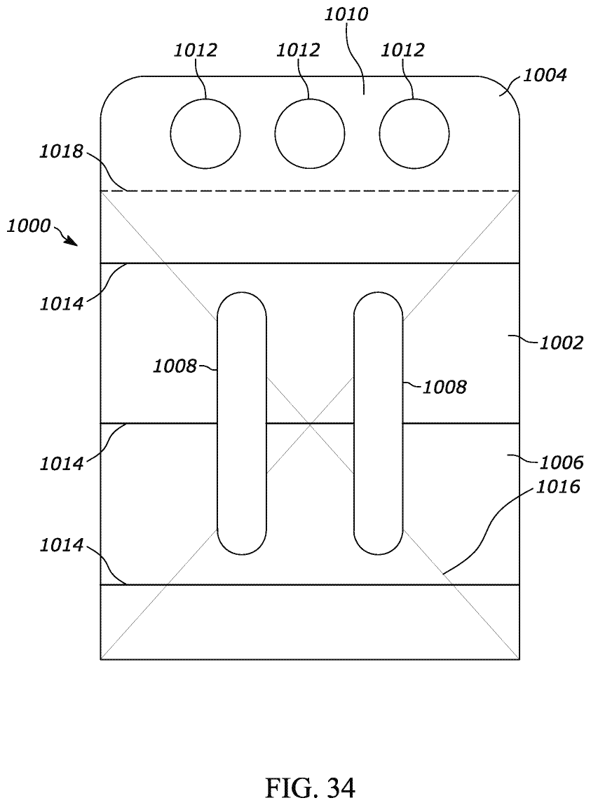

A similar form of modification of a package is shown in FIG. 34. A lid 1000 is shown having top wall 1002 and flap 1004, which may be used in combination with any of the other packaging walls described herein. The top wall 1002 can include a susceptor layer 1006 and openings 1008. Similarly, the flap 1004 includes susceptor layer 1010 and openings 1012. It should be appreciated that the susceptor layers 1006, 1010, as well as openings 1008, 1012 may have a variety of sizes, shapes, patterning, location, and the like as described elsewhere herein. In some forms, the openings 1012 may be larger than other openings so that slight misalignments of the flap 1004 may still permit moisture to escape from the cooking space. The lid 1000 may be connected to a remainder of the package or may be a separate component, such that it can be considered as a card that is inserted into the package with the flap 1004 positioned between the food product and an outer side wall. It should be appreciated that the top wall 1002 and flap 1004 can have the same susceptor patterning, such as 100% patterning, to keep construction simple.

Lid 1000 also includes modifications similar to those discussed above with respect to FIG. 33. For example, lid 1000 includes creases 1014 and partial cuts 1016. The lid 1000 also includes modifications, such as in the form of dead fold 1018, which can include one or more of a perforation, score, partial cut, and the like. The dead fold 1018 can help the flap 1004 fold when the lid is positioned to close the comestible cooking space. The dead fold 1018 may also help minimize deformation, as noted above.

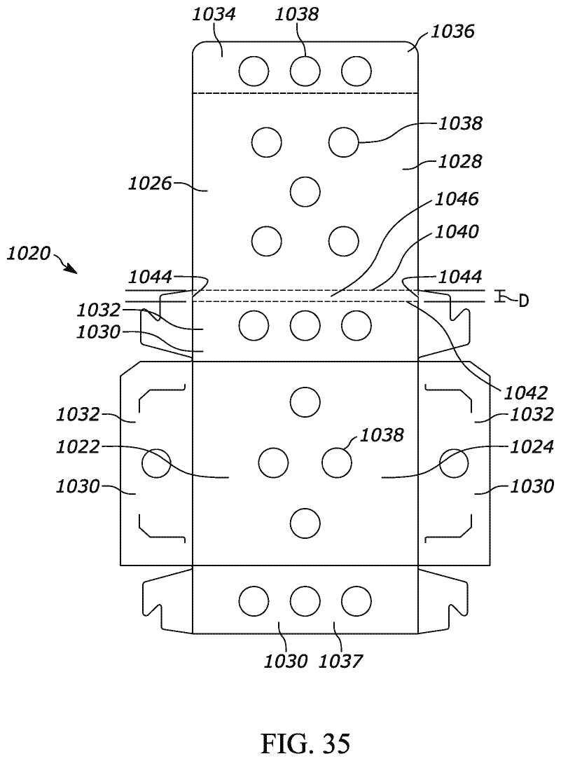

A package 1020 is shown in FIG. 35. The package 1020 may include many similar features described above, such as openings, susceptor layers, different patterns of susceptor layers, and the like. For the sake of brevity, these features will not be discussed in detail, but instead will focus on some of the different features further included in the package 1020. However, it should be appreciated that the features described herein elsewhere can also be included in the package 1020.

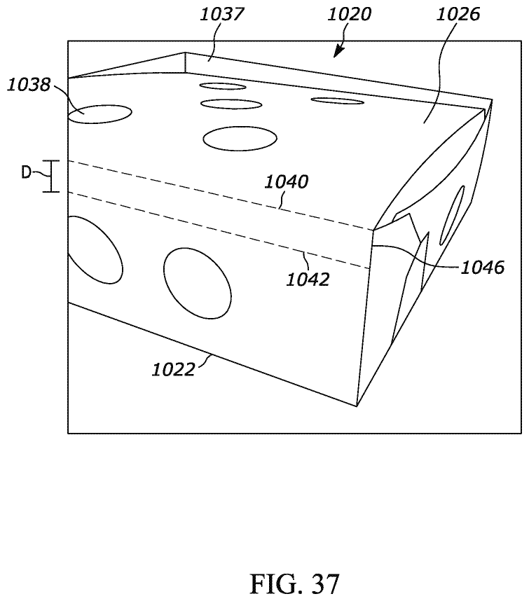

Package 1020 generally is shown in the form of a blank in FIG. 35, prior to folding into a package to enclose a comestible cooking space. The package 1020 includes a bottom wall 1022 having susceptor 1024, a top wall 1026 having a susceptor 1028, and side walls 1030 having susceptors 1032. The package 1020 also includes a flap 1034 having a susceptor 1036. It should be appreciated that when folded to enclose a comestible cooking space, the flap 1034 may be positioned inwardly relative to front portion 1037 such that front portion 1037 does not need to have a susceptor due to the placement of susceptor 1036, as will be appreciated from FIGS. 37-40. In one form, susceptors 1024, 1028 are 100% patterned susceptors while susceptors 1032,1036 are less than 100% patterned, such as 75% patterned susceptors. Further, openings 1038 may be included and have different shapes and sizes depending on the location in the package 1020 and may be included on each of the walls.

Package 1020 also includes a first hinge 1040 positioned adjacent the top wall 1026 and a second hinge 1042 positioned adjacent the first hinge 1040. The first and second hinges 1040,1042 are located a distance “D.” The first and second hinges 1040,1042 can include scores, partial cuts, and the like so as to form dead folds, similar to the dead fold discussed above. The first hinge 1040 is configured to permit the top wall 1026 to be positioned a first distance from the bottom wall 1022 when the package is closed while the second hinge 1042 permits the top wall 1026 to be positioned a second distance from bottom wall 1022, which is smaller than the first distance. The package 1020 may also include perforations 1044 to permit a portion 1046 of the top wall 1026 to separate from the side wall 1032, generally represented by the distance D. The function and position of these structures will be further understood from FIGS. 37-40 and the below discussion.

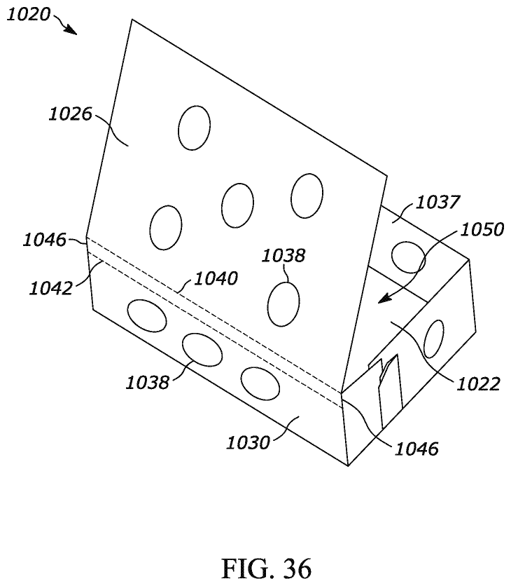

FIG. 36 illustrates package 1020 folded with the top wall 1026 in an open position so that a user may access comestible cooking space 1050. FIG. 37 illustrates the package 1020 with the top wall 1026 in a generally closed position to enclose the comestible cooking space 1050. In this form, the top wall 1026 pivots about hinge 1040. In this form, the top wall 1026 is positioned a first distance from bottom wall 1022. This configuration permits a larger food item to be placed in the comestible cooking space 1050.

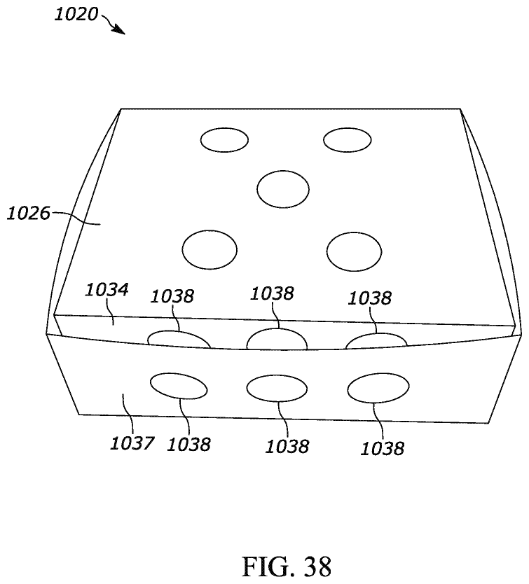

FIG. 38 shows a front perspective view of the package 1020 in the same configuration as in FIG. 37. As seen in FIG. 38, the flap 1034 is positioned inwardly of portion 1037. In this form, openings 1038 in the flap may substantially align with openings 1038 in portion 1037.

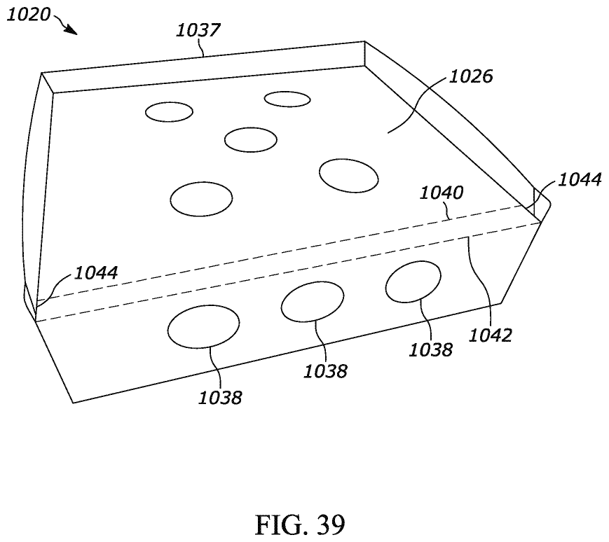

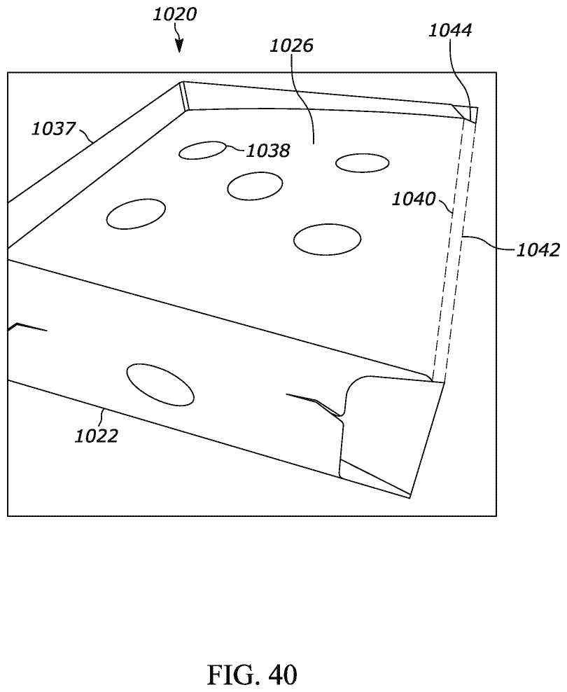

FIGS. 39 and 40 illustrate the package 1020 in a second configuration. In the second configuration, the top wall 1026 pivots about second hinge 1042 instead of first hinge 1040. In this configuration, the top wall 1026 is able to be positioned lower towards the bottom wall 1022 than when in the first configuration. Therefore, the top wall 1026 is able to contact a food that is smaller. The package 1020 may therefore be able to accommodate multiple sized food products while still maintaining contact with the top wall 1026. It should be appreciated that the openings 1038 in the flap 1034 may or may not align as equally with openings 1038 in the portion 1037 as in the first configuration and vice versa. Similarly, the openings 1038 in the flap 1034 may be larger than openings 1038 in the portion 1037 so that slight misalignment of the flap 1034 does not substantially affect migration of moisture therethrough.

It should be appreciated the size, positioning, shape, and exposed area from the vent openings may be modified for different foods and microwave heating processes. In some forms, each of the top wall, the bottom wall, and/or the at least one side wall independently can have a minimum of 2% of the overall surface area as exposed vent openings. According to some forms, each of the top wall, bottom wall, and at least one side wall can have different percentages of exposed surface area as vent openings. For example, each of the top wall, bottom wall, and at least one side wall can independently have an exposed vent area of 2%, 5%, 8%, 10%, 12%, 15%, 18%, 20%, 22%, 25%, or more. In some forms, only the top wall and/or bottom wall include vent openings. According to some forms, if there are multiple sides walls, all of the side walls can include vent openings. In other forms, one or more of the multiple side walls do not include any vent openings.

Similarly, the amount and type of susceptor material may also be modified in a given package and for a given wall. For example, in some forms, the susceptor material cover at least 80% of the overall, non-exposed surface area of the top wall and/or bottom wall. In some forms, 90% or more of the non-exposed surface area of the top wall and bottom wall include susceptor material. In some forms, the top wall and bottom wall include at least 75% patterned susceptor material. According to some forms, the top wall and bottom wall include at least 90% patterned susceptor material, at least 95% patterned susceptor material, and/or 100% patterned susceptor material. Similarly, the side walls can include varying amounts and types of patterned susceptor materials. For example, in some forms, the susceptor material cover at least 80% of the overall, non-exposed surface area of the side wall. In some forms, 90% or more of the non-exposed surface area of the side wall include susceptor material. In some forms, the side wall includes at least 25% patterned susceptor material. According to some forms, the side wall include at least 40% patterned susceptor material, at least 50% patterned susceptor material, and/or at least 75% % patterned susceptor material. It should be appreciated that the side wall can include up to 100% patterned susceptor material.

The relative amounts of the various patterned susceptor material may also be varied. For example, the at least one side wall may have a relatively lower patterned susceptor material whereas the top and bottom walls may include relatively higher patterned susceptor materials. For the total susceptor materials in a package, the at least one side wall may have about 10-40% susceptor surface area and the top and bottom wall may have about 60-90% of the total susceptor surface area. For example, 50% patterned susceptor material may account for about 25% of the total susceptor area and 100% patterned susceptor material may account for about 75% of the total susceptor area. These relative amounts may be modified, as desired.

The amount of surface area of susceptor material to exposed vent opening surface area may also be adjusted for a particular package and/or product. For example, the ratio of susceptor surface area to exposed venting area can be 12:1, 10:1, 9:1, 8:1, and the like.

As noted above, the package can be formed from a blank having a bottom portion, side portions, and a top portion. The blank can be formed from a support material that is suitable for forming into the package, such as a carton. The support material can take a variety of forms and can include one or more layers. In some forms, the blank can include paperboard that has one or more susceptors added thereto along with the absorbent material.

The package may be formed by laminating the three macro layers (i.e., the susceptor layer, the absorbent material, and the paperboard base) together. When forming a package with generally coextensive layers, the three layers may be generally continuously or intermittently unspooled from rolls and laminated (or otherwise attached) together. In another configuration, such as when the susceptor is inset on the paperboard base layer, a discrete susceptor may be cut from a roll of susceptor film and then applied, such as by adhesive, or otherwise laminated, to the paperboard base and/or absorbent pad after registration therewith.

The package can also be used such that the package itself forms the package directly contacting the food product when sold to a consumer. The food product may be contained directly within this package. In some forms, the packaging includes a further inner packaging, such as a wrapper, containing the food product within the microwavable package having at least one susceptor. In this regard, a consumer can tear the inner wrapper, remove the food product from the wrapper and then place the food product back within the susceptor package for heating.

The food product may be frozen prior to placement in the partially assembled package. Alternatively, the food product may be frozen after the formation, filling, and sealing of the package is completed.

In certain broad aspects, this invention concerns the use of a contact susceptor in combination with a plurality of non-contact susceptors to substantially surround a food product to be heated, where the non-contact susceptors function to reflect incident microwave radiation away from the food product and to convert microwave radiation to thermal radiation directed toward one or more surface portions of the food product. Accordingly, it will be appreciated that, while the description herein has been directed to a carton having generally rectangular prism form, the carton could also have other shapes and still fall within the spirit and scope of this disclosure. By way of example, packages which are polygonal, arcuate, curved or circular when viewed from above are within the spirit and scope of this disclosure. To similar effect, cross-sectional shape of the package may also have configurations other than the generally rectangular shape shown and described above.

While the foregoing describes in detail a microwaveable carton having multiple focused susceptors, methods of making the carton, and methods of use, it will be apparent to one skilled in the art that various changes and modifications may be made to the disclosed carton and methods and further that equivalents may be employed, which do not materially depart from the spirit and scope of the invention. Accordingly, all such changes, modifications, and equivalents that fall within the spirit and scope of the invention as defined by the appended claims are intended to be encompassed thereby.

1. A microwavable package for a comestible, the microwavable package comprising:
a bottom wall, the bottom wall defining a vent opening extending at least partially through the bottom wall, the bottom wall having a bottom susceptor layer having a first pattern percentage of susceptor material to non-susceptor material;
a top wall including a top wall susceptor having a second pattern percentage of susceptor material to non-susceptor material; and
at least one side wall positioned between the bottom wall and the top wall having a side wall susceptor having a third pattern percentage of susceptor material to non-susceptor material, the at least one side wall, bottom wall, and top wall generally surrounding a comestible cooking space,
wherein the third pattern percentage is less than the first and second pattern percentages.

2. The microwavable package of claim 1, wherein at least one of the first and second pattern percentages is 100% and the third pattern percentage is 90% or less.

3. The microwavable package of claim 1, wherein the top wall is coupled to the at least one side wall, the top wall further including a flap, the flap including a flap susceptor.

4. The microwavable package of claim 3 wherein the at least one side wall includes a side wall vent opening and the flap includes a flap vent opening such that the side wall vent opening and flap vent opening are substantially aligned when the top wall is closed to surround the comestible cooking space.

5. The microwavable package of claim 1, wherein the top wall includes a top wall vent opening and the at least one side wall includes a side wall vent opening.

6. The microwavable package of claim 1, wherein the bottom wall is generally rectangular and includes corners, wherein at least a portion of the corners do not include susceptor material.

7. The microwavable package of claim 1, wherein the top wall is separate from the bottom wall and at least one side walls, the top wall being positionable within a perimeter of the at least one side wall.

8. A microwavable package for a comestible, the microwavable package comprising:
a bottom wall;
plurality of side walls extending from the bottom wall;
a top wall forming a lid operably coupled to at least one of the plurality of side walls, the top wall, bottom wall, and plurality of side walls generally surrounding a comestible cooking space;
a first hinge positioned adjacent the top wall to permit the top wall to be located a first distance from the bottom wall; and
a second hinge positioned adjacent the first hinge to permit the top wall to be located a second distance from the bottom wall, the second distance being smaller than the first distance.

9. The microwavable package of claim 8, wherein a portion of the top wall is removably separable from at least one of the side walls.

10. The microwavable package of claim 8, further comprising a susceptor layer positioned on at least one of the bottom wall, top wall, and plurality of side walls.

11. The microwavable package of claim 8, wherein the bottom wall includes a bottom susceptor layer having a first pattern percentage of susceptor material to non-susceptor material, the top wall includes a top wall susceptor having a second pattern percentage of susceptor material to non-susceptor material, and the plurality of side walls each includes a side wall susceptor having a third pattern percentage of susceptor material to non-susceptor material, wherein the third pattern percentage is less than the first and second pattern percentages.

12. The microwavable package of claim 11, wherein at least one of the first and second pattern percentages is 100% and the third pattern percentage is 90% or less.

13. The microwavable package of claim 11, wherein the top wall further includes a flap, the flap including a flap susceptor.

14. The microwavable package of claim 13 wherein the at least one side wall includes a side wall vent opening and the flap includes a flap vent opening such that the side wall vent opening and flap vent opening are substantially aligned when the top wall is closed to surround the comestible cooking space.

15. The microwavable package of claim 8, further comprising a vent positioned on at least one of the bottom wall, top wall, and plurality of side walls.

16. The microwavable package of claim 1, wherein the bottom wall is generally rectangular and includes corners, wherein at least a portion of the corners do not include susceptor material.

17. A microwavable package for a comestible, the microwavable package comprising:
a bottom wall, the bottom wall defining a bottom vent opening extending through the bottom wall;
plurality of side walls extending from the bottom wall, each of the plurality of side walls including a side vent opening extending through a respective side wall;
a top wall forming a lid and having a top wall vent opening extending through the top wall, the top wall, bottom wall, and plurality of side walls generally surrounding a comestible cooking space; and
a susceptor material positioned on at least one of the bottom wall, top wall, and plurality of side walls facing the comestible cooking space.

18. The microwavable package of claim 17, wherein the microwavable package has an outer surface area when surrounding the comestible cooking space such that the bottom vent opening, side vent openings, and top wall opening account for at least about 5% of the outer surface area.

19. The microwavable package of claim 17, further comprising a susceptor layer positioned on at least one of the bottom wall, top wall, and plurality of side walls.

20. The microwavable package of claim 17, wherein the top wall further includes a flap, the flap having a flap vent opening such that at least one side wall vent opening, and flap vent opening are substantially aligned when the top wall is closed to surround the comestible cooking space

21-42. (canceled)
